(19) United States
(12) Patent Application Publication
(10) Pub. No.: US 2006/0252471 A1
(43) Pub. Date: Nov. 9, 2006

(54) Tilting and sliding mobile device

(75) Inventor: Long-Jyh Pan, Taipei County (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/402,815

(22) Filed: Apr. 13, 2006

(30) Foreign Application Priority Data
Apr. 15, 2005 (TW) 94111991

(51) Int. Cl. H04M 1/00

(52) U.S. Cl. 455/575.4

(57) ABSTRACT

A tilting and sliding mobile device. The tilting and sliding mobile device comprises a first module, a second module, and a connecting module. The first module comprises a display device. The second module is slidably connected to the first module at an adjustable angle. The connecting module, with one end connecting to the first module and another end connecting to the second module, comprises a tilting component and a sliding component. The tilting component is tiltably connected to the sliding component at an angle, which is adjustable with respect to relative movement of the first and the second module.

### BACKGROUND

The invention relates to an electronic device, and in particular to a tilting and sliding mobile device.

Mobile devices such as cell phones, calculators, personal digital assistants (PDAs), and notebooks have various styles. To satisfy different demands, designs and colors of cell phones are numerous, for example, upright, flip, and sliding styles. Consumers not only demand good communication quality with friendly user interface, but also additional functions such as camera, low power-consumption, and large display. Appearance is also critical. Thus, manufacturers try to satisfy both functionality and appearance of mobile devices for accommodating different consumer requirements and attracting different age groups. Sliding mobile devices have become very popular.

FIG. 1A is a schematic view of a conventional sliding mobile device 10 in a closed state or before sliding. FIG. 1B is a schematic view of the conventional sliding mobile device 10 after sliding. As shown in FIGS. 1A and 1B, the conventional mobile device 10 comprises a display module 1 and a body 2, and the display module 1, slidably disposed on the body 2, comprises a screen 3 and a function keypad 4. The body 2 comprises a number keypad 5 and a pair of tracks 6. The display module 1 is movable in direction A along the tracks 6, and after sliding, the number keypad 5 on the body 2 is revealed. The mobile device 10 has different function, such as a mobile phone with PDA or touch panel; however, when placed on a desk, the viewing angle of the screen is limited. Thus, the conventional mobile device is inconvenient to use and cannot accommodate the multi-function designs thereof.

### SUMMARY

The invention provides a tilting and sliding mobile device with both tilting and sliding functions that can be viewed at various viewing angles.

Also provided is a tilting and sliding mobile device comprising a first module, a second module, and a connecting module connecting the first and second modules. The first module comprises a display device. The second module is slidably connected to the first module at an adjustable angle. The connecting module, with one end connecting to the first module and another end connecting to the second module, comprises a tilting component and a sliding component. The tilting component is tiltably connected to the sliding component at an angle, adjustable with respect to relative movement of the first and second modules. When the first module slides on the second module, the tilting component and the sliding component form an angle between 0 and 90°.

The first module further comprises a first cover, a second cover, and a first keypad. The first cover is connected to the second cover, and the second cover is connected to the tilting component of the connecting module. The first keypad penetrates the first/cover.

The tilting and sliding mobile device further comprises a flexible printed circuit board, transmitting signals, penetrating the connecting module and electrically connecting the first module and the second module.

The second cover comprises a slot, through which the flexible printed circuit board penetrates.

The first keypad comprises a plurality of function keys.

The second cover comprises two holes, and the tilting component comprises two hook portions, passing through the holes to connect the first module, the second module, and the connecting module.

The second module comprises a third cover, a fourth cover, a circuit board, and a second keypad. The third cover is connected to the fourth cover and slidably connected to the sliding component. The second keypad and the circuit board are disposed between the third cover and the fourth cover.

The third cover comprises a pair of first tracks, disposed in the vicinity of the second keypad, and a pair of second tracks, with width greater than that of the first tracks, disposed in the vicinity of the bottom of the display device and connected to the first tracks. The sliding component is clamped and slidable on the first tracks and the second tracks. When the sliding component slides from the first tracks to the second tracks, the tilting component tilts up.

The sliding component comprises a pair of sliding portions, slidably disposed on the first tracks and the second tracks, respectively. The tilting component comprises a pair of lift portions, slidably disposed on the first tracks and the second tracks, respectively.

The depth of each lift portion decreases from the second keypad toward the display device. Each lift portion comprises an inclined side forming an inclined angle with a horizon and a flange, engaged with the first tracks and the second tracks. When the inclined side moves along the first tracks, the inclined angle thereof determines the angle between the first module and the second module.

The third cover comprises a pair of first positioning element, disposed in a first position and a second positioning element, disposed in a second position. The connecting module is movable on the third cover between the first position and the second position.

The sliding component of the connecting module further comprises a third positioning element. When the third positioning element engages with the first positioning element of the third cover, the tilting component is compressed downward and pushed against the sliding component such that the first module closes on the second module and is parallel thereto. When the third positioning element engages with the second positioning element, the first module slides to the second position and the second keypad of the second module is revealed.

In an embodiment, the first positioning element and the second positioning element comprise at least one protrusion, and the third positioning element comprises at least one opening; the protrusion engages with the opening for positioning.

The second keypad comprises a plurality of number keys and a plurality of character keys.

The connecting module further comprises an elastic member, comprising an end connected to the tilting component and another end connected to the sliding component such that the adjustable angle formed between the tilting component and the sliding component is adjusted by elasticity of the elastic member.

### BRIEF DESCRIPTION OF THE DRAWINGS

The invention can be more fully understood by reading the subsequent detailed description in conjunction with the examples and references made to the accompanying drawings, wherein:

FIG. 1A is a perspective view of a conventional sliding mobile device;

FIG. 1B is a perspective view of a conventional sliding mobile device after sliding;

FIG. 2A is an exploded view of a tilting and sliding mobile device of the invention;

FIG. 2B is a schematic view of a tilting and sliding mobile device of the invention after assembly;

FIGS. 3A-1 and 3A-2 are combined to show an exploded view showing each element of a tilting and sliding mobile device of the invention;

FIG. 3B is a schematic view of a connecting module from a different viewing angle;

FIG. 4A is a schematic view of a second module and a connecting module assembled in a first position;

FIG. 4B is a schematic view of a second module and a connecting module assembled in a second position;

FIGS. 5A to 5F are side views showing continuous motion of a tilting and sliding mobile device of the invention.

### DETAILED DESCRIPTION

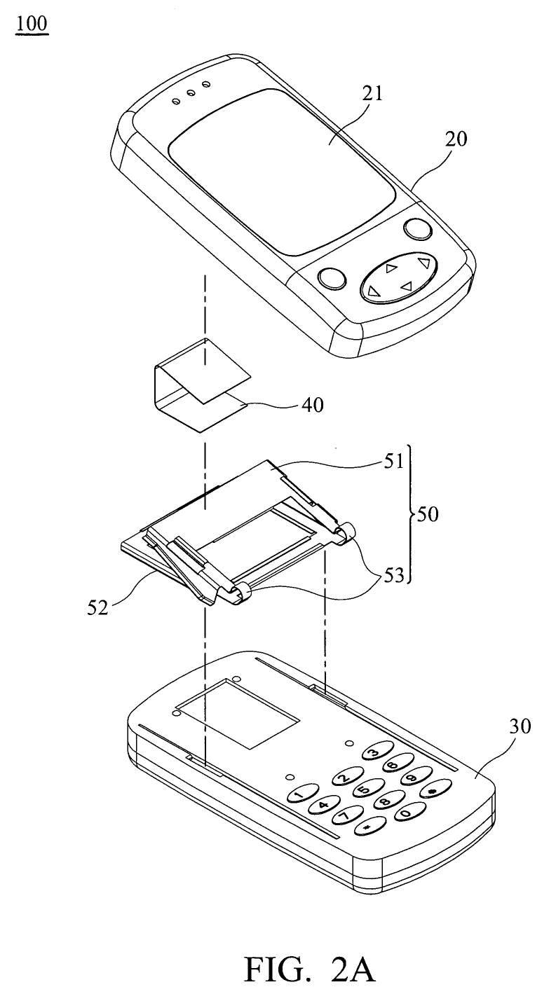

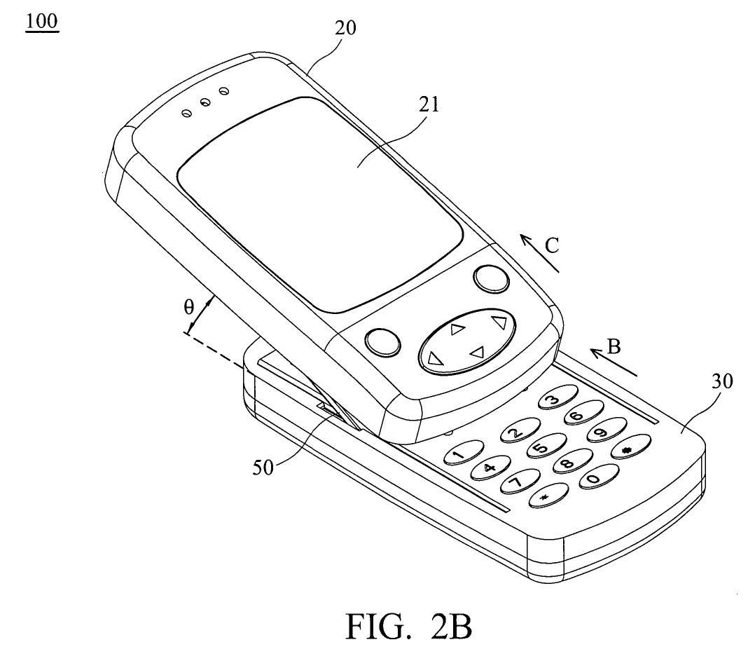

FIG. 2A is an exploded view of a tilting and sliding mobile device 100 of the invention. The tilting and sliding mobile device 100 of the invention can be applied to various electronic devices with covers such as mobile phones, calculators, PDAs, and notebooks. Note that in the following embodiments and figures, a cell phone is described as an example.

The tilting and sliding mobile device 100 comprises a first module 20, a second module 30, a flexible printed circuit board (FPCB) 40, and a connecting module 50. The first module 20 comprises a display device 21 for displaying images. The second module 30 is tiltably and slidably disposed on the first module 20. The FPCB 40 for transmitting signals penetrates the connecting module 50 to connect the first module 20 and the second module 30. The connecting module 50 comprises a tilting component 51, a sliding component 52, and at least one elastic member 53. In this embodiment, the elastic member 53 is curved to connect the tilting component 51 and the sliding component 52. That is, the elastic member 53 of the connecting module 50 has one end connecting to the tilting component 51 and another end connecting to the sliding component 52 such that an adjustable angle formed between the tilting component 51 and the sliding component 52 is adjusted by elasticity of the elastic member 53. The tilting component 51 is connected to the first module 20 and the second module 30. The sliding component 52 is connected to the second module 30. Thus, the tilting component 51 is tiltably connected to the sliding component 52 at an angle via the elastic member 53.

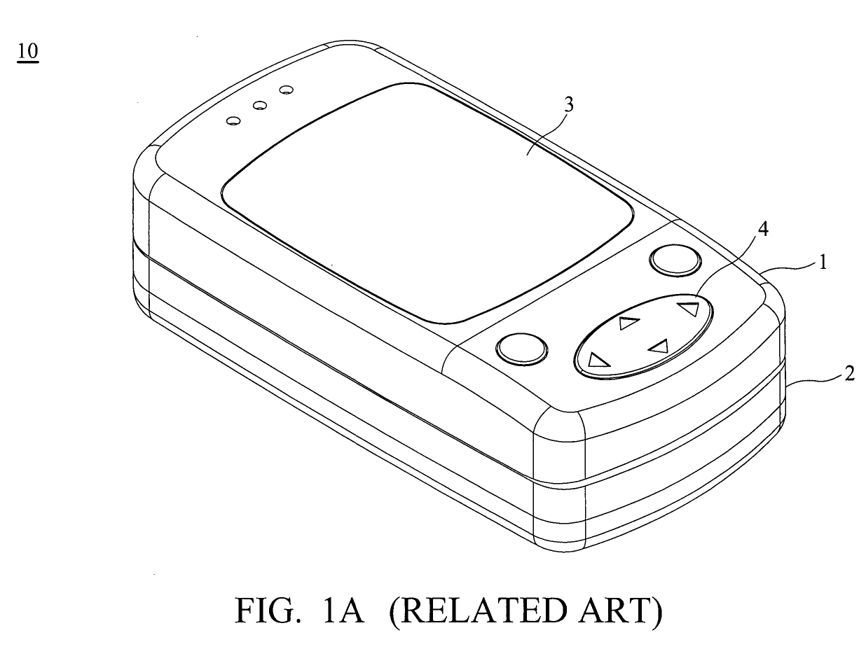

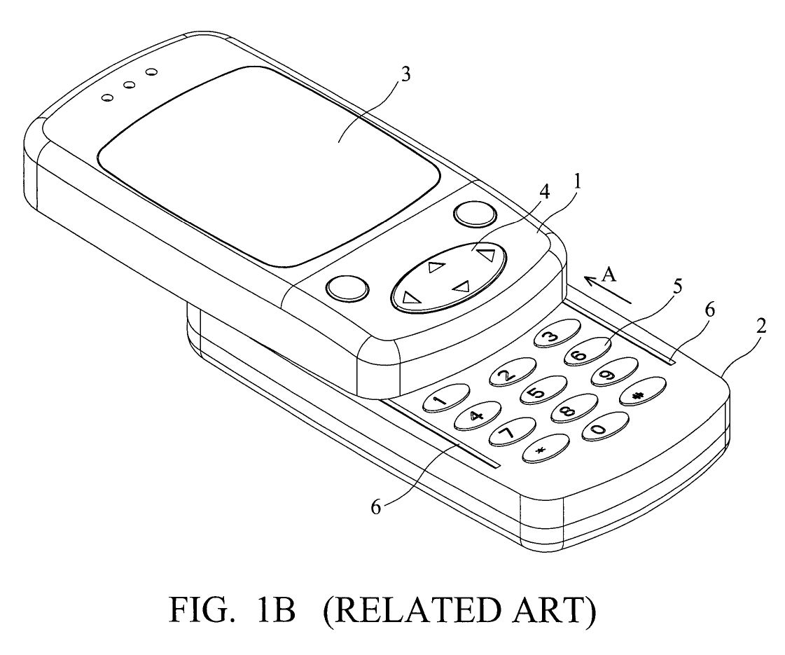

FIG. 2B is a schematic view of the tilting and sliding mobile device 100 of the invention after assembly. After the first module 20 and the second module 30 are combined, the connecting module 50 is disposed between the first module 20 and second module 30. Note that the connecting module 50 is blocked by the first module 20 and not visible in this view. Thus, please also refer to the connecting module 50 of FIG. 2A. When the first module 20 slides on the second module 30 in direction B, the first module 20 is tilted up at an angle θ in direction C by the connecting module 50. In detail, the tilting component 51 and the sliding component 52 (FIG. 2A) allow the first module 20 to form the angle θ with respect to the second module 30. The tilting component and the sliding component form an angle between 0 and 90°, preferably, 0 and 45°. Thus, the first module 20 of the tilting and sliding mobile device 100 slides back and forth relative to the second module 30 in direction A, the same as the conventional design in FIG. 1B, and also tilts up after sliding, as shown in FIG. 2B.

The following describes the first module 20, the connecting module 50, and the second module 30.

FIGS. 3A-1 and 3A-2 are combined to show an exploded view showing each element (the first module 20, and connecting module 50, and the second module 30) of the tilting and sliding mobile device 100 of the invention. The first module 20 comprises a first cover 22, a second cover 25, and a first keypad 24. The first module 20 contains the display device 21. The first cover 22 is connected to the second cover 25. The display device 21 is disposed between the first cover 22 and the second cover 25. The first keypad 24 comprises a plurality of function keys 241, 242, each passing through corresponding hole 23 of the first cover 22 and exposed thereon. The second cover 25 comprises two holes 252, and the tilting component 51 comprises two hook portions 514, passing through the holes 252 to connect the first module 20, the second module 30, and the connecting module 50. Moreover, the second cover 25 comprises a slot 251, through which the flexible printed circuit board 40 penetrates.

As shown in FIGS. 3A-1 and 3A-2, the second module 30 comprises a third cover 31, a fourth cover 34, a circuit board (PCB) 33, and a second keypad 32. The third cover 31 is connected to the fourth cover 34. The second keypad 32 comprises a plurality of number keys 32a and a plurality of character keys 32a, each penetrates a corresponding hole 31a of the third cover 31 and is exposed thereon. The second keypad 32 and the circuit board 33 are disposed between the third cover 31 and the fourth cover 34. Note that the third cover 31 is slidably connected to the sliding component 52 of the connecting module 50. In addition, the third cover 31 comprises a pair of first tracks 313, disposed in the vicinity of the second keypad 32, and a pair of second tracks 315, disposed in the vicinity of the bottom of the display device 21 and connected to the first tracks 313. The sliding component 52 is clamped, and is slidable on the first tracks 313 and the second tracks 315. Width of the second tracks 315 is greater than width of the first tracks 313. When the sliding component 52 slides from the first tracks 313 to the second tracks 315, the tilting component 51 of the connecting module 50 tilts up.

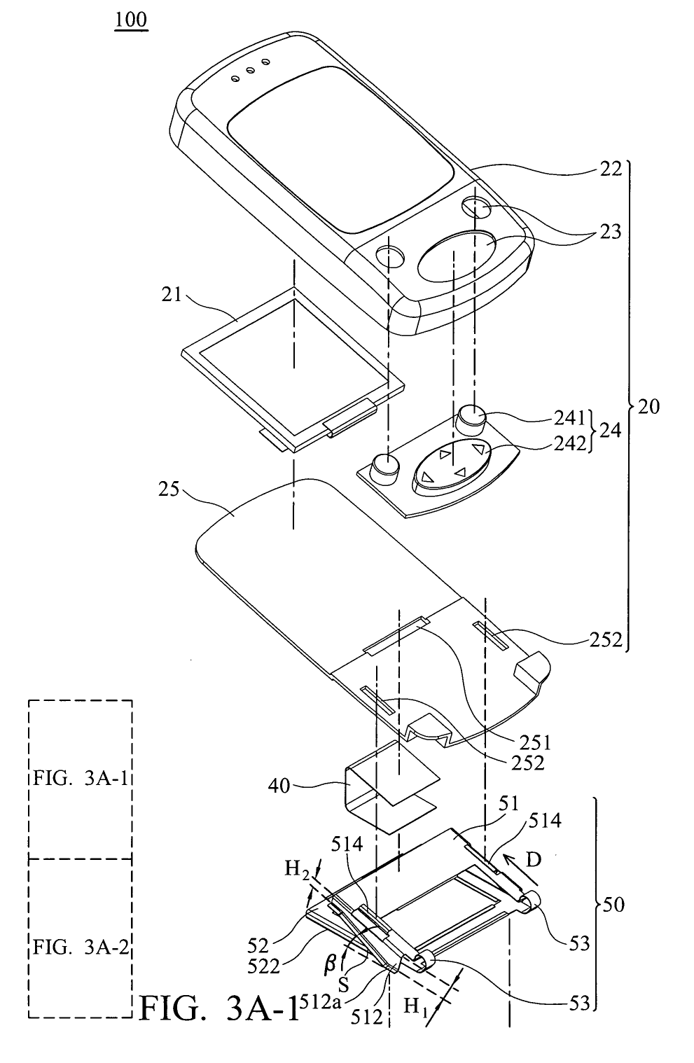

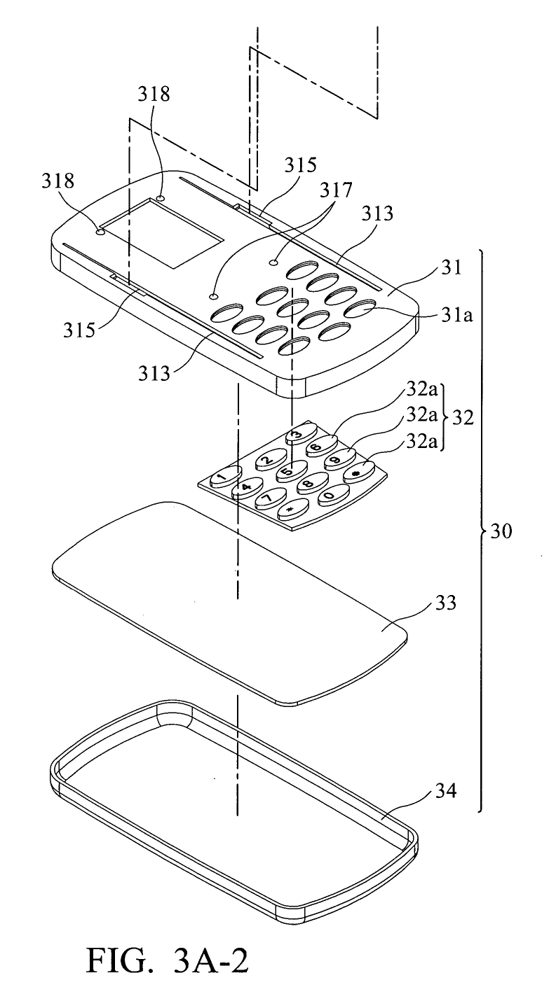

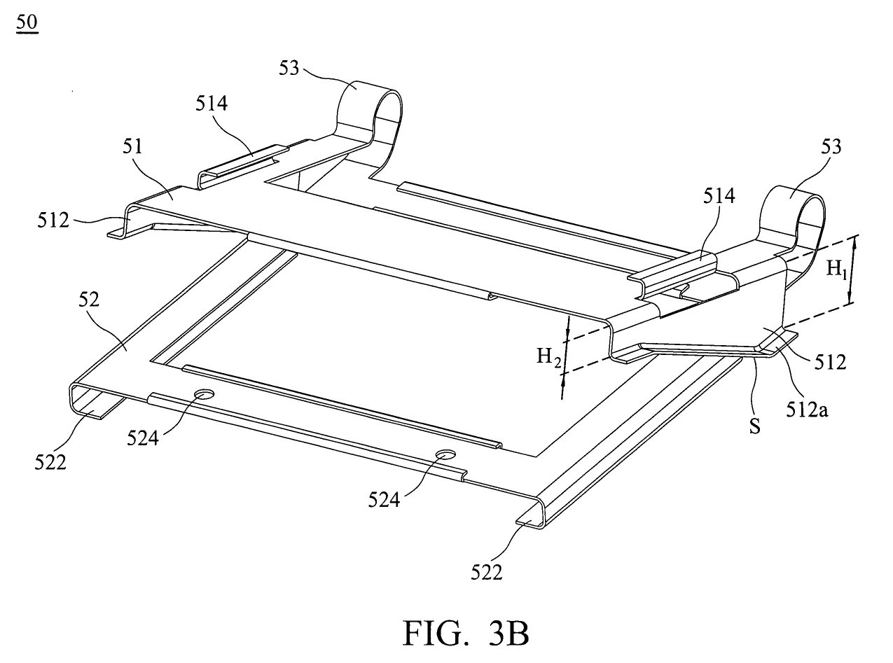

FIG. 3B is a schematic view of a connecting module 50 from a different viewing angle. As shown in FIGS. 3A-1 and 3B, the sliding component 52 of the connecting module 50 comprises a pair of sliding portions 522, slidably disposed on the first tracks 313 and the second tracks 315, respectively. The tilting component 51 comprises a pair of lift portions 512, slidably disposed on the first tracks 313 and the second tracks 315, respectively. Each lift portion 512 comprises a flange 512a, protruding toward the sides of the tracks, and is engaged with the first tracks 313 and the second tracks 315. The depth of each lift portion 512 decreases from the second keypad 32 toward the display device 21 in direction D. That is, the depth of the lift portions 512 decreases from H₁ to H₂. Additionally, each lift portion 512 has an inclined side S forming an inclined angle β with a horizon, about 0-45°. When the inclined side S moves along the first tracks 313 toward the second tracks 315, the inclined angle β thereof determines the angle θ between the first module 20 and the second module 30, as shown in FIG. 2B. Since the elastic member 53 is flexible, when the lift portion 512 engages with the first tracks 313, the tilting component 51 is pushed against the sliding component 52. Due to depth reduction of the lift portion 512, when the tilting component 51 slides on the tracks 313 or 315, the tilting component 51 and the sliding component 52 form the angle β by elasticity of the elastic member 53.

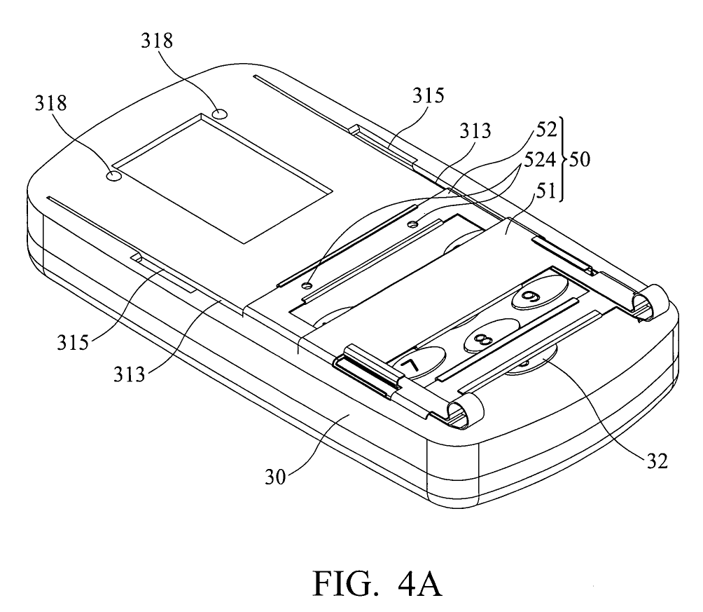

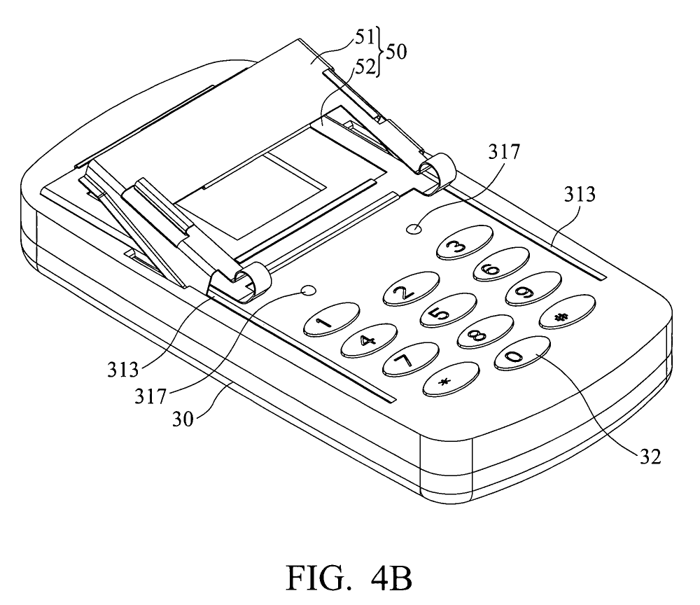

FIG. 4A is a schematic view of the second module 30 and the connecting module 50 assembled in the first position, from which the first module 20 is eliminated to clearly show the connecting module 50. FIG. 4B is a schematic view of the second module 30 and the connecting module 50 assembled in the second position.

As shown in FIGS. 3A-1, 3A-2, 3B, 4A, and 4B, the third cover 31 of the second module 30 comprises a first positioning element 317, disposed in the first position (FIG. 4B) and a second positioning element 318, disposed in a second position (FIG. 4A). The connecting module 50 is movable on the third cover 31 between the first position and the second position. The sliding component 52 of the connecting module 50 further comprises a third positioning element 524. When the third positioning element 524 engages with the first positioning element 317 of the third cover 31 (FIGS. 3A-1, 3A-2 and 4A), the tilting component 51 is compressed downward and pushed against the sliding component 52 such that the first module 20 closes on the second module 30 and parallel thereto, having an appearance the same as the conventional design in FIG. 1A. When the third positioning element 524 engages with the second positioning element 318, the first module 20 slides to the second position and the second keypad 32 of the second module 30 is revealed. Note that when the connecting module 50 is in the second position, the tilting component 51 can either tilt up (as shown in FIG. 2B), or abut the sliding component 52 (as shown in FIG. 1B). That is when the tilting component 51 passes the second track 315, the tilting component 51 can be released to tilt up or pushed against the sliding component 52 until the sliding component 52 reaches the second position. In this embodiment, the first positioning element 317 and the second positioning element 318 comprise at least one protrusion, and the third positioning element 524 comprises at least one opening to be engaged with the protrusions.

In some embodiments, the first positioning element 317 and the second positioning element 318 comprise at least one opening (not shown), and the third positioning element 524 comprises at least one protrusion (not shown) to be engaged with the opening.

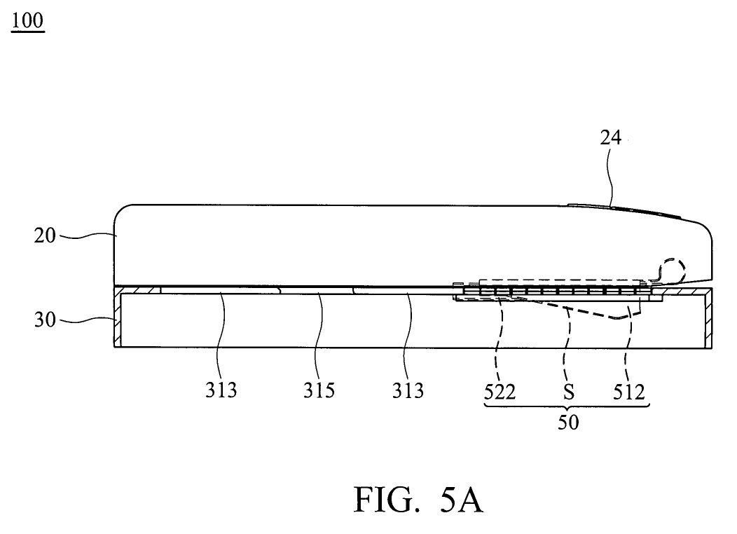

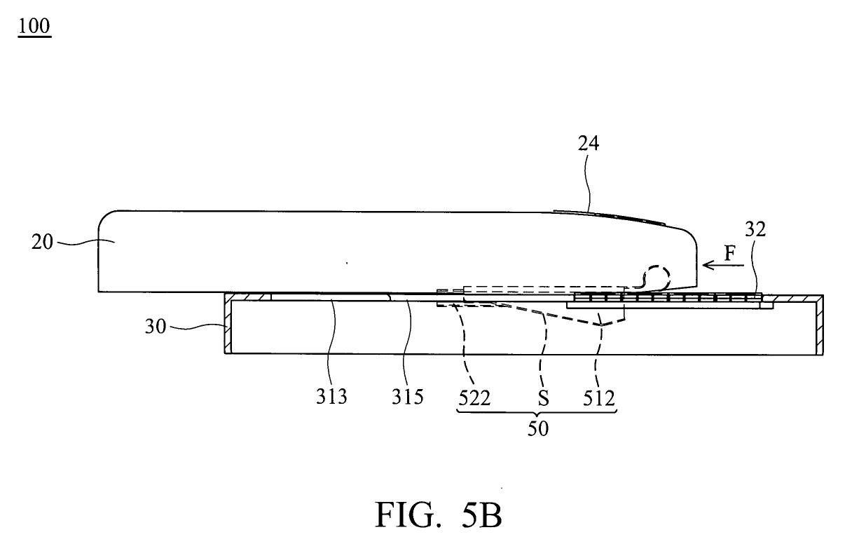

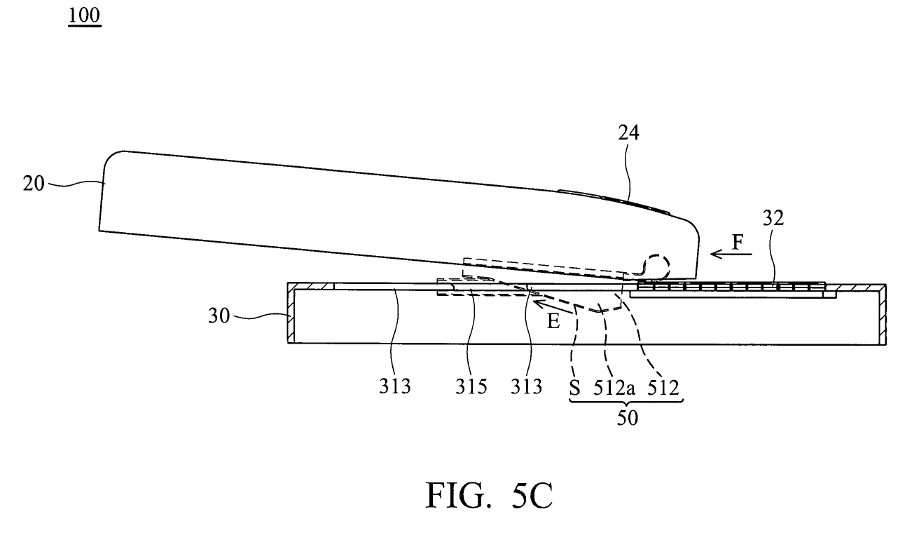

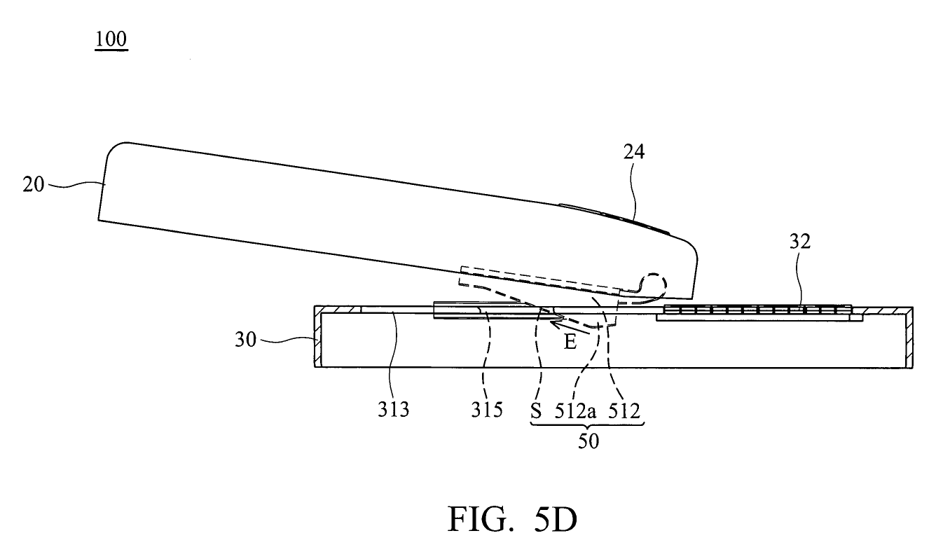

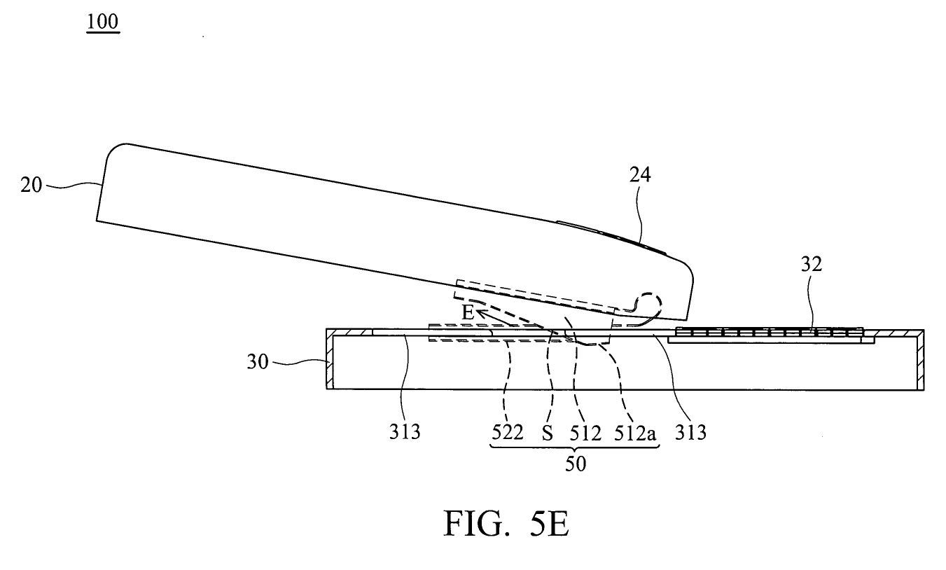

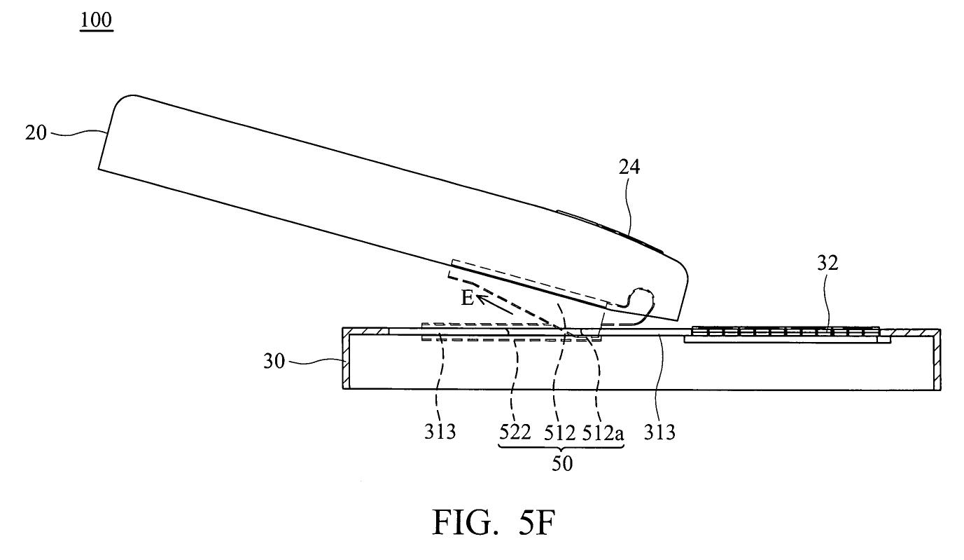

FIGS. 5A to 5F are side views showing continuous motion of the tilting and sliding mobile device 100 of the invention. In FIG. 5A, the tilting and sliding mobile device 100 is idle without sliding. User can listen to the phone while operating the first keypad 24. In FIG. 5B, the first module 20 slides against the second module 30 via the sliding component of the connecting module in direction F such that the second keypad 32 is revealed.

In FIGS. 5C to 5F, when the sliding portion 522 further moves in direction F, the lift portion 512 of the tilting component 51 of the connecting module 50 raises gradually in direction E such that the second module 20 is tilted up. In FIGS. 5C and 5D, since the inclined side S of the lift portion 512 slides along the first tracks 313 and the second tracks 315, the inclined angle of the first module 20 is determined by the inclined side S. Thus, the first module 20 keeps rising until the second position is reached, as shown in FIG. 5F.

In conclusion, when using the mobile device of the invention, users do not need to slide the second module 30 to receive calls while using the keypad 24. When calls are placed, the second module 30 slides to reveal the second keypad 32, as shown in FIG. 2B. Moreover, the screen 21 of the first module 20 can be tilted up at an inclined angle, such that users can read and use in different angles. Thus, the operation is more convenient. The assembly is simple without increasing manufacture costs.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A tilting and sliding mobile device, comprising:
a first module comprising a display device;
a second module, slidably connected to the first module at an adjustable angle; and
a connecting module with one end connecting to the first module and another end connecting to the second module, comprising a tilting component and a sliding component, wherein the tilting component is tiltably connected to the sliding component at an angle, adjustable with respect to relative movement of the first and the second module.

2. The tilting and sliding mobile device as claimed in claim 1, wherein when the first module slides on the second module, the tilting component and the sliding component form an angle between 0 and 90°.

3. The tilting and sliding mobile device as claimed in claim 1, wherein the first module further comprises a first cover, a second cover, and a first keypad; wherein the first cover is connected to the second cover, and the second cover is connected to the tilting component of the connecting module; and the first keypad penetrates the first cover.

4. The tilting and sliding mobile device as claimed in claim 3, further comprising a flexible printed circuit board for transmitting signals, penetrating the connecting module and electrically connecting the first module and the second module.

5. The tilting and sliding mobile device as claimed in claim 4, wherein the second cover comprises a slot, through which the flexible printed circuit board penetrates.

6. The tilting and sliding mobile device as claimed in claim 3, wherein the first keypad comprises a plurality of function keys.

7. The tilting and sliding mobile device as claimed in claim 3, wherein the second cover comprises two holes, and the tilting component comprises two hook portions passing through the holes to connect the first module, the second module, and the connecting module.

8. The tilting and sliding mobile device as claimed in claim 1, wherein the second module comprises a third cover, a fourth cover, a circuit board, and a second keypad; wherein the third cover is connected to the fourth cover and slidably connected to the sliding component; and the second keypad and the circuit board are disposed between the third cover and the fourth cover.

9. The tilting and sliding mobile device as claimed in claim 8, wherein the third cover comprises a pair of first tracks, disposed in the vicinity of the second keypad, and a pair of second tracks, with width greater than the first tracks, disposed in the vicinity of the bottom of the display device and connected to the first tracks; the sliding component is clamped and slidable on the first tracks and the second tracks; and when the sliding component slides from the first tracks to the second tracks, the tilting component tilts up.

10. The tilting and sliding mobile device as claimed in claim 9, wherein the sliding component comprises a pair of sliding portions, slidably disposed on the first tracks and the second tracks, respectively; and the tilting component comprises a pair of lift portions, slidably disposed on the first tracks and the second tracks, respectively.

11. The tilting and sliding mobile device as claimed in claim 10, wherein the depth of each lift portion decreases from the second keypad toward the display device.

12. The tilting and sliding mobile device as claimed in claim 10, wherein each lift portion comprises an inclined side forming an inclined angle with a horizon, and a flange, engaged with the first tracks and the second tracks; wherein when the inclined side moves along the first tracks, the inclined angle thereof determines the angle between the first module and the second module.

13. The tilting and sliding mobile device as claimed in claim 8, wherein the third cover further comprises a first positioning element, disposed in a first position and a second positioning element, disposed in a second position; and the connecting module is movable on the third cover between the first position and the second position.

14. The tilting and sliding mobile device as claimed in claim 13, wherein the sliding component of the connecting module further comprises a third positioning element; wherein when the third positioning element engages with the first positioning element of the third cover, the tilting component is compressed downward and pushed against the sliding component such that the first module closes on the second module and is parallel thereto; and when the third positioning element engages with the second positioning element, the first module slides to the second position and the second keypad of the second module is revealed.

15. The tilting and sliding mobile device as claimed in claim 14, wherein the first positioning element and the second positioning element comprise at least one protrusion, and the third positioning element comprises at least one opening; and the protrusion engages with the opening for positioning.

16. The tilting and sliding mobile device as claimed in claim 8, wherein the second keypad comprises a plurality of number keys and a plurality of character keys.

17. The tilting and sliding mobile device as claimed in claim 1, wherein the connecting module further comprises an elastic member, one end connected to the tilting component and another end connected to the sliding component such that the adjustable angle formed between the tilting component and the sliding component is adjusted by elasticity of the elastic member.
